(19) United States
(12) Patent Application Publication
(10) Pub. No.: US 2010/0156266 A1
(43) Pub. Date: Jun. 24, 2010

(54) GAS DISCHARGE LIGHT EMITTING PANEL

(75) Inventors: Takehiro Zukawa, Osaka (JP); Seigo Shiraishi, Osaka (JP); Kojiro Okuyama, Nara (JP); Junichi Hibino, Kyoto (JP); Keiji Horikawa, Osaka (JP)

Correspondence Address: HAMRE, SCHUMANN, MUELLER & LARSON P.C., P.O. BOX 2902, MINNEAPOLIS, MN, 55402-0902, US

(73) Assignee: MATSUSHITA ELECTRIC INDUSTRIAL CO., LTD., Kadoma-shi, Osaka (JP)

(21) Appl. No.: 11/997,084

(22) PCT Filed: Jul. 26, 2006
(86) PCT No.: PCT/JP2006/314780

§ 371 Date: Jan. 28, 2008

(30) Foreign Application Priority Data
Jul. 27, 2005 (JP) 2005-217087

(51) Int. Cl. H01J 17/49

(52) U.S. Cl. 313/487; 313/485

(57) ABSTRACT

A gas discharge light emitting panel is provided that prevents deterioration in display properties of the panel, which accompanies changes in light-emitting properties of phosphors. It includes a front panel and a rear panel that are disposed to oppose each other, with a discharge space being interposed therebetween, and a phosphor layer that is disposed above a principal surface located on the discharge space side of the rear panel and that emits light by being irradiated with ultraviolet rays generated in the discharge space. The phosphor layer contains first and second phosphors in which the changes in at least one property selected from luminance and chromaticity, which accompany driving of the panel, occur in the opposite directions to each other.

### TECHNICAL FIELD

The present invention relates to a gas discharge light emitting panel, which is an image display device that utilizes light emitted by phosphors irradiated with ultraviolet rays generated through gas discharge.

### BACKGROUND ART

Recently, gas discharge light emitting panels, typically plasma display panels (PDPs), are being developed as image display devices that can achieve high resolution and high luminance. It is easy to increase the size of PDP screens and thereby further widespread use of PDPs is expected from now on.

In a PDP, a full color image is displayed through additive color mixing of three primary colors: red, green, and blue. In order to perform such image display, the PDP includes, in each discharge cell, a phosphor layer containing a phosphor (a red phosphor, a green phosphor, or a blue phosphor) that emits light of each color of red, green, or blue. Each phosphor is excited by irradiation with ultraviolet rays (vacuum ultraviolet rays) generated through gas discharge in a discharge space to emit light. Thus, light of each color described above is emitted. The discharge cells are arranged in a predetermined pattern. The timing of gas discharge in each discharge cell, i.e. timing of irradiating the phosphors with ultraviolet rays is controlled and thereby images are displayed on a panel. The specific configuration of the PDP is disclosed in, for example, Heiju Uchiike and Shigeo Mikoshiba, May 1, 1997, “ALL ABOUT PLASMA DISPLAY”, Kogyo Chosakai, pp. 79-80.

It has been known that in a PDP, changes in light-emitting properties with time, which accompany driving of the panel, occur in each discharge cell. Conceivably, the changes often are caused by deterioration of phosphors due to, for instance, ion bombardment at the time of discharge or vacuum ultraviolet ray irradiation. The deterioration of phosphors results in a decrease in conversion efficiency at which ultraviolet rays are converted into visible light, and typically, deterioration in luminance and a change in chromaticity are caused. When such a change is caused, the following tends to occur particularly when a certain image is displayed continuously as in the case of a still image, for example. That is, since the properties of light (light-emitting properties, for example, luminance and/or chromaticity) emitted by the phosphors differ among the discharge cells that are different from one another in lighting time, a phenomenon (generally referred to as an “image persistence phenomenon”) in which a previous pattern is viewed as an afterimage may occur when a different pattern from the above-mentioned certain pattern is displayed.

Generally, BAM (BaMgAl₁₀O₁₇:Eu²⁺) is employed as blue phosphors to be used in a PDP because its luminance and chromaticity at the time of emission are suitable for image display devices. BAM, however, tends to cause a decrease in luminance and a change in chromaticity, which accompany driving of the panel, particularly the decrease in luminance. Accordingly, a method is being tried in which BAM and other phosphors with different light-emitting properties from those of BAM are combined together to be used as blue phosphors.

For instance, JP 2005-116363 A (Document 1) discloses a technique in which a blue phosphor layer is formed as a layer composed of a mixture of at least two types of blue phosphors that are different from each other in both initial luminance and a change in luminance with time. Document 1 describes a combination of BAM and CaMgSi₂O₆:Eu²⁺ (CMS) as a specific composition of the blue phosphor layer (see Examples). In Examples, the following is described. That is, the initial luminance of CMS is lower than that of BAM, but when the panel is driven for 1000 hours, the rate of decrease in luminance of CMS is lower than that of BAM (the luminance of BAM decreased by 38%, while that of CMS decreased by 2%), and the decrease in luminance of the blue phosphor layer, which accompanies driving of the panel, can be reduced as compared to the case where the blue phosphor layer is formed of BAM alone.

Furthermore, in JP 2003-313549 A (Document 2), a mixture of BAM and a phosphor obtained by substituting a part of Ca of CMS by Sr is indicated as a blue phosphor having high luminance after plasma exposure. It should be considered that in the invention according to Document 2, a technique for increasing the initial luminance of blue phosphors is disclosed, since the plasma exposure employed in Examples is carried out for 15 minutes following the heat treatment for forming a phosphor layer.

Under such a situation, there are needs for a gas discharge light emitting panel that reduces changes in light-emitting properties of phosphors (phosphor layer) accompanying driving of the panel and prevents the display properties of the panel from deteriorating with time.

### DISCLOSURE OF INVENTION

The present inventors achieved such gas discharge light emitting panels by using different configurations from those of the conventional techniques described above.

A gas discharge light emitting panel of the present invention includes a front panel and a rear panel that are disposed to oppose each other, with a discharge space being interposed therebetween, and a phosphor layer that is disposed above a principal surface located on the discharge space side of the rear panel and that emits light by being irradiated with ultraviolet rays generated in the discharge space. The phosphor layer contains first and second phosphors in which changes in at least one property selected from luminance and chromaticity, which accompany driving of the panel, occur in the opposite directions to each other.

A gas discharge light emitting panel of the present invention viewed from an aspect different from the above includes a front panel and a rear panel that are disposed to oppose each other, with a discharge space being interposed therebetween, and a phosphor layer that is disposed above a principal surface located on the discharge space side of the rear panel and that emits light by being irradiated with ultraviolet rays generated in the discharge space. The phosphor layer contains a first phosphor represented by a formula, aSrO.bEuO.MgO.cSiO₂, and BaMgAl₁₀O₁₇:Eu²⁺ as a second phosphor. In the above-mentioned formula, a, b, and c satisfy the following relationships: 2.97≦a≦3.5, 0.001≦b≦0.03, and 1.9≦c≦2.1.

According to the present invention, a phosphor layer is provided that contains phosphors in which changes in at least one property selected from luminance and chromaticity, which accompany driving of the panel, occur in the opposite directions to each other, and thereby the changes in light-emitting properties of the phosphor layer, which accompany driving of the panel, can be reduced and the display properties of the panel can be prevented from being deteriorated with time.

### BRIEF DESCRIPTION OF DRAWINGS

FIG. 1 is a schematic view showing an example of a plasma display panel (PDP) as a gas discharge light emitting panel of the present invention.

FIG. 2 is a schematic diagram showing an example of changes in luminance of a phosphor layer.

FIG. 3 is a schematic diagram showing an example of changes in chromaticity of a phosphor layer.

FIG. 4A is a graph showing the change in luminance in each phosphor layer sample measured in Example 1.

FIG. 4B is a graph showing the change in chromaticity in each phosphor layer sample measured in Example 1.

### DESCRIPTION OF THE PREFERRED EMBODIMENTS

Hereinafter, embodiments of the present invention are described with reference to the drawings. In the following description, the identical components are indicated with identical reference numerals and the same explanation may not be repeated.

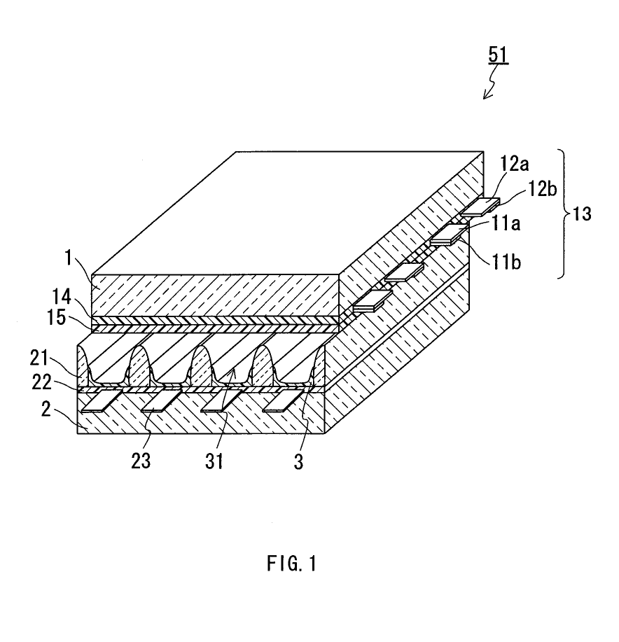

An example of plasma display panel (PDP) is shown in FIG. 1 as a gas discharge light emitting panel of the present invention.

A PDP 51 shown in FIG. 1 includes a pair of substrates (a front panel 1 and a rear panel 2) disposed to oppose each other, with discharge spaces 31 being interposed therebetween, and phosphor layers 3 disposed above the principal surface located on the discharge space 31 side of the rear panel 2. The phosphor layers 3 each contain first and second phosphors as phosphors that emit light by being irradiated with ultraviolet rays generated in the discharge spaces 31. In the first and second phosphors, changes in at least one property selected from luminance and chromaticity, which accompany driving of the panel (accompany light emission of themselves), occur in the opposite directions to each other. In such a PDP 51, the light-emitting properties of the first and second phosphors are changed in the opposite directions to each other upon driving of the panel. Accordingly, the changes in light-emitting properties of the phosphor layer 3 can be reduced and thereby the display properties of the panel can be prevented from deteriorating. In this specification, the changes in luminance and chromaticity are changes that accompany driving of the panel (i.e. during driving of the panel), unless otherwise described. The change in luminance can be indicated, for example, by an increase or a decrease in value (Y/y) to be described later. The change in chromaticity can be indicated, for example, by an increase or a decrease in value of chromaticity y to be described later.

When the phosphor layers 3 each contain the first and second phosphors in which changes in luminance occur in the opposite directions to each other, that is, when the phosphor layers 3 each contain a first phosphor whose luminance increases and a second phosphor whose luminance decreases, the change in luminance of the phosphor layer 3 can be reduced. This case also can be described as a case where the change in the first phosphor occurs in a direction in which the luminance increases.

Conventionally, in phosphors used for a gas discharge light emitting panel such as a PDP, the luminance thereof generally tends to be decreased by driving of the panel. The same applies to not only BAM and CMS but also the phosphors disclosed in Document 1 (JP 2005-116363 A) and Document 2 (JP 2003-313549 A). Accordingly, for example, when a phosphor layer is formed to contain a conventional phosphor whose luminance is decreased, as the second phosphor, and a phosphor whose luminance is increased, as the first phosphor, the decrease in luminance of the phosphor layer can be reduced. The effect obtained thereby is superior to that obtained in the case where different types of phosphors whose luminances decrease are combined together as in Documents 1 and 2.

A gas discharge light emitting panel that performs full-color display includes three types of phosphor layers that contain respective phosphors of blue, green, and red as phosphor layers, respectively. Among them, the luminance of the blue phosphor (blue phosphor layer) tends to be decreased greatly. Therefore, it is preferable that the blue phosphor layer contain a conventional blue phosphor whose luminance decreases, as the second phosphor, and a phosphor whose luminance increases, as the first phosphor. In this case, in order to obtain a good display property, it is preferable that the above-mentioned first phosphor also be a blue phosphor. That is, in the panel of the present invention, it is preferable that the first and second phosphors be blue phosphors. In this case, the effect of the present invention is particularly prominent. The blue phosphor denotes a phosphor having an emission spectrum peak in the wavelength range of 440 to 470 nm, typically in the wavelength range of 450 to 460 nm.

Examples of the phosphor whose luminance increases include silicate phosphors such as Sr₂Si₃O₈:Eu and Ba₃MgSi₂O₃:Eu. Conceivably, since these phosphors each contain Si oxide as the base material thereof, they tend to be affected by gas or discharge and the structures thereof tend to be changed in the direction in which the luminance increases.

Preferably, a phosphor represented by a formula, aSrO.bEuO.MgO. cSiO₂ (hereinafter, referred to as “SMS”) is used as the phosphor whose luminance increases. In the above-mentioned formula, a, b, and c satisfy the following relationships: 2.97≦a≦3.5, 0.001≦b≦0.03, and 1.9≦c≦2.1. The ranges of a, b, and c denote that the oxygen deficient or excess state in SMS is tolerated. The stoichiometric composition in SMS is a+b=3 and c=2. SMS that satisfies the stoichiometric composition can be represented by a formula, Sr₃MgSi₂O₈:Eu, with Eu serving as an activating element. Conventionally, there are phosphors containing a base material and an activating material that are composed of similar elements to those of SMS. However, those conventional phosphors do not provide sufficiently high luminance and chromaticity during light emission. Accordingly, they are not used as phosphors for gas discharge light emitting panels such as a PDP until now. In SMS having the composition represented by the formula described above, however, the luminance and chromaticity thereof satisfy the properties required for phosphors to be used for gas discharge light emitting panels. Therefore it is preferable that SMS be used as the first phosphor of the present invention.

In SMS, Eu serves as an activating element. Preferably, the ratio of divalent Eu (an atomic fraction of divalent Eu atoms in the entire Eu atoms having different valences from each other) in the vicinity of the surface of a SMS particle (in the range from the surface of the SMS particle to about 10 nm) is 50% or lower. Such SMS allows luminance and chromaticity that are obtained during light emission to be further suitable for a PDP and also further can ensure the increase in luminance that is achieved by driving of the panel.

SMS is a blue phosphor having an emission spectrum peak at a wavelength of 460 nm. Therefore, it is preferable that SMS be contained in the blue phosphor layer together with the second phosphor, which is a blue phosphor. In other words, in the PDP 51, it is preferable that the blue phosphor layer contain SMS. Furthermore, in other words, it is preferable that the blue phosphor layer contain SMS as the first phosphor and a blue phosphor as the second phosphor, with the blue phosphor having an emission spectrum peak in the wavelength range of 440 to 470 nm, typically in the wavelength range of 450 to 460 nm.

SMS also can be described as a phosphor containing 2.97 to 3.5 mol of SrO, 0.001 to 0.03 mol of EuO, and 1.9 to 2.1 mol of SiO₂ with respect to 1 mol of MgO.

The type of the blue phosphor to be combined with SMS is not particularly limited. However, BaMgAl₁₀O₁₇:Eu²⁺ (BAM) is preferred because it has high emission efficiency. BAM is a blue phosphor whose luminance is decreased by driving of the panel. Other phosphors to be combined with SMS are, for example, CaMgSi₂O₄:Eu²⁺, Sr₃MgSi₂O₈:Eu²⁺, and (SrBa)₃MgSi₂O₈:Eu²⁺. These phosphors are blue phosphors and the luminance thereof tends to be decreased by driving of the panel.

When the phosphor layer 3 contains SMS as the first phosphor and BAM as the second phosphor, the ratio between these two components contained therein is not particularly limited. For example, a ratio of BAM:SMS is approximately 25:75 to 75:25 in terms of volume fraction.

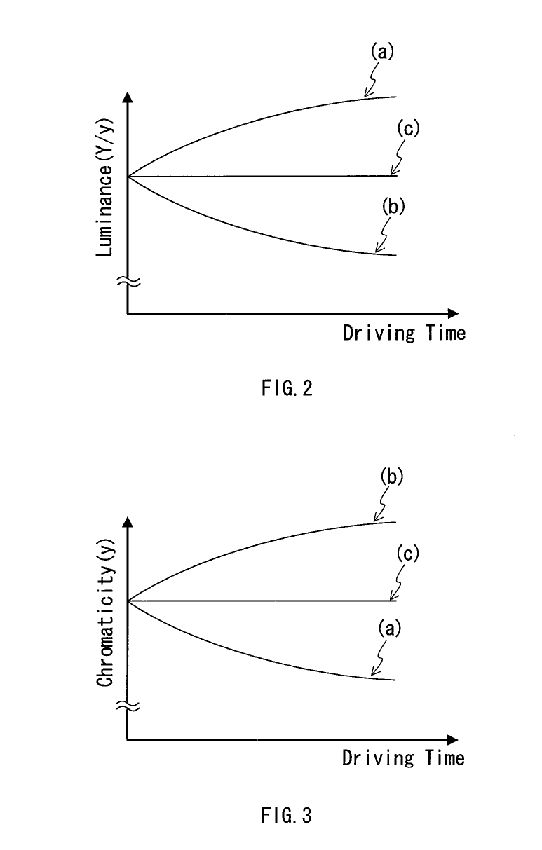

FIG. 2 shows an example of changes in luminance in the phosphor layer 3 containing SMS and the second phosphor whose luminance is decreased by driving of the panel. In the example shown in FIG. 2, the luminance of SMS tends to increase with time, during which the panel is driven, as indicated with (a). The luminance of the second phosphor tends to decrease with time, during which the panel is driven, as indicated with (b). When the phosphor layer 3 contains both the phosphors, the change in luminance can be reduced as indicated with (c) as compared to the case where the second phosphor alone is contained. The luminance shown in FIG. 2 is indicated by a value (Y/y) obtained by dividing the stimulus value Y in the XYZ color system defined by Commission Internationale de l'Eclairage (CIE) by chromaticity y in the chromaticity coordinate (x, y) based on the color system, in order to cancel the change in chromaticity through the driving of the panel.

The first phosphor is not particularly limited, so long as it is a phosphor whose luminance is increased by driving of the panel. In order further to ensure the reduction of the change in luminance of the phosphor layer, it is preferable that the rate of increase in luminance of the phosphor be at least a predetermined value. Specifically, the value (Y/y) increases preferably by at least 3%, more preferably by at least 8%, and further preferably by at least 10% per 1000 hours for which the panel is driven. As described later in Examples, SMS satisfies this increase rate depending on the composition thereof, the aforementioned ratio of divalent Eu, or production conditions.

The changes in luminance of the first and second phosphors need not always occur in the opposite directions to each other by driving of the panel, as long as they occur in the opposite directions to each other for at least a part of the period of time, for which the panel is driven (that is, the period of time, for which the first and second phosphors themselves emit light).

In conventional phosphors including BAM and CMS, the luminance thereof decreases constantly during the period of time, during which the panel is driven (the period of time, for which the phosphors themselves emit light). Accordingly, when these conventional phosphors are used as the second phosphor, the luminance of the first phosphor need not necessarily be increased continuously by driving of the panel, as long as it is increased for at least a part of the period of time, during which the panel is driven. For example, the rate of increase in luminance described above can be a rate of increase that is obtained during a period of 1000 hours after the start of driving the panel for aging, with a phosphor layer being formed above the principal surface of a rear panel by processes such as application and baking, or during a period of 1000 hours after the start of driving the panel for usual image display after completion of aging.

When the phosphor layer 3 contains the first and second phosphors in which the changes in chromaticity occur in the opposite directions to each other, for example, when the phosphor layer 3 contains a phosphor whose chromaticity y is increased by driving of the panel and a phosphor whose chromaticity y is decreased by driving of the panel, the change in chromaticity of the phosphor layer 3 can be reduced. In this case, “chromaticity y” denotes chromaticity y in the chromaticity coordinate (x, y) based on the XYZ color system defined by Commission Internationale de l'Eclairage (CIE). The “change in chromaticity” is not limited to that in chromaticity y described as an example and can be any change in chromaticity, as long as the change in chromaticity is that in at least one chromaticity selected from chromaticity x and chromaticity y in the chromaticity coordinate (x, y) described above.

Conventionally, blue phosphors that have been used for gas discharge light emitting panels such as PDPs generally have a tendency for the chromaticity y thereof to be increased by driving of the panel. The same applies to not only BAM and CMS but also the phosphors disclosed in Documents 1 and 2. Therefore, when a phosphor layer is formed that contains, for example, a conventional phosphor whose chromaticity y is increased, as the second phosphor, and a phosphor whose chromaticity y is decreased, as the first phosphor, the change in chromaticity y of the phosphor layer can be reduced.

Examples of the blue phosphors whose chromaticity y is decreased include silicate phosphors such as Sr₂Si₃O₈:Eu and Ba₃MgSi₂O₃:Eu. Conceivably, since these phosphors each contain Si oxide as the base material thereof, they tend to be affected by gas or discharge and therefore the structures thereof tend to be changed in the direction in which the chromaticity y increases.

Preferably, the above-mentioned SMS is used for the phosphor whose chromaticity y is decreased. As described above, conventional blue phosphors that have been used for gas discharge light emitting panels such as PDPs generally have a tendency for the chromaticity y to be increased by driving of the panel. Therefore, for example, when a phosphor layer is formed that contains a conventional blue phosphor whose chromaticity y is increased, and SMS whose chromaticity y is decreased, the change in chromaticity of the blue phosphor layer can be reduced. Thus, also from the viewpoint that the change in chromaticity can be reduced, it is preferable that the blue phosphor layer contain SMS.

The type of the blue phosphor to be combined with SMS is not particularly limited. BAM is preferable because of its high emission efficiency. BAM is a blue phosphor whose chromaticity y is increased by driving of the panel. Other examples of the phosphor to be combined with SMS include CaMgSi₂O₄:Eu²⁺, Sr₃MgSi₂O₈:Eu²⁺, and (SrBa)₃MgSi₂O₈:Eu²⁺, as blue phosphors. These phosphors have a tendency that the chromaticity y thereof is increased by driving of the panel.

FIG. 3 shows an example of the changes in chromaticity y in a phosphor layer 3 containing SMS and a second phosphor whose chromaticity y is increased by driving of the panel. In the example shown in FIG. 3, the chromaticity y of SMS tends to decrease with time, during which the panel is driven, as indicated with (a), while the chromaticity y of the second phosphor tends to increase with time, during which the panel is driven, as indicated with (b). When the phosphor layer 3 contains both the phosphors, the change in chromaticity y can be reduced as indicated with (c) as compared to the case where the second phosphor alone is contained.

The changes in chromaticity y of the first and second phosphors need not always occur in the opposite directions to each other by driving of the panel, as long as they occur in the opposite directions to each other for at least a part of the period of time, during which the panel is driven.

The phosphor layer 3 may contain one type or more of phosphors (third phosphor) other than the first and second phosphors. The direction in which the above-mentioned at least one property of the third phosphor changes is not particularly limited. For instance, it may be the same direction as that of the change that occurs in the first phosphor or it may be the same direction as that of the change that occurs in the second phosphor.

The contents of the first and second phosphors in the phosphor layer 3 are not particularly limited. They can be determined arbitrarily according to the type of the phosphors contained therein or the light-emitting properties required for the phosphor layer 3. The content of the first phosphors in the phosphor layer 3 is, for example, in the range of 25 to 75 vol %.

In the first and second phosphors, both the luminances and chromaticities thereof may be changed in the opposite directions to each other, respectively, by driving of the panel.

In the PDP 51, it is not necessary for all the phosphor layers 3 to contain the first and second phosphors. For example, the blue phosphor layers alone may contain the first and second phosphors, or only the phosphor layers 3 located in the region where the luminance and/or chromaticity changes considerably in the panel may contain the first and second phosphors.

The configuration and structure of each component of the PDP 51 and the material to be used for each component are not particularly limited, so long as the phosphor layer 3 contains the first and second phosphors, and so long as they provide a general configuration and structure as a PDP.

In the PDP 51 shown in FIG. 1, display electrodes 13, a dielectric layer 14, and a protective layer 15 are disposed on the principal surface of a front panel 1. The display electrodes 13 each include a sustain electrode 11 and a scan electrode 12. The protective layer 15 protects the dielectric layer 14 from plasma that is generated in the discharge spaces 31. Address electrodes 23, a dielectric layer 22, and barrier ribs 21 are disposed on the principal surface of a rear panel 2. The dielectric layer 22 protects the address electrodes from the plasma described above. The PDP 51 is an AC PDP with a so-called three-electrode structure. FIG. 1 shows only a part of the respective electrodes and barrier ribs of an actual PDP, with some of them being omitted.

The material to be used for the front panel 1 is not particularly limited as long as it has translucency. For instance, a glass substrate may be used. The material to be used for the rear panel 2 is not particularly limited. For instance, a substrate containing glass and/or metal may be used. Generally, a glass substrate is used for each of the front panel 1 and the rear panel 2.

A striped sustain electrodes 11 and scan electrodes 12 are disposed in parallel with each other as a display electrodes 13 on the front panel 1.

The sustain electrode 11 and the scan electrode 12 are configured to have a transparent electrode (sustain electrode) 11a and a bus electrode (sustain electrode) 11b that are stacked together and a transparent electrode (scan electrode) 12a and a bus electrode (scan electrode) 12b that are stacked together, respectively. For example, indium tin oxide (ITO) or tin oxide may be used for the transparent electrodes 11a and 12a. For the bus electrodes 11b and 12b, for instance, aluminum, copper, silver, or a laminate including chromium and copper may be used. A black film made of glass and a black pigment, which is referred to as a black stripe for improving the black display quality and improving the contrast of an image, is disposed between a sustain electrode 11 and a scan electrode 12 although it is not shown in the drawing. Each electrode and black film included in a display electrode 13 can be formed on the principal surface of the front panel 1 by a technique such as screen printing, for example.

The dielectric layer 14 is disposed on the front panel 1 so as to cover the display electrodes 13. The protective layer 15 is disposed on the dielectric layer 14 (on the discharge space 31 side of the dielectric layer 14). The dielectric layer 14 serves as a capacitor that accumulates electric charges when the PDP 51 displays images. A material that is employed commonly for a PDP is used for the dielectric layer 14. For instance, it can be a layer formed of low-melting glass that contains, as its main component, for example, lead oxide (PbO), bismuth oxide (Bi₂O₃), or phosphorus oxide (P₂O₅). The dielectric layer 14 can be formed by applying a dielectric paste obtained by kneading low-melting glass, resin, and a solvent onto the front panel 1 by a method such as printing (for instance, screen printing or die coating) or transfer (for example, a film lamination method), and then drying and baking it.

A material that is employed commonly for a PDP also is used for the protective layer 15. The protective layer 15 may be a layer formed of, for example, MgO. The protective layer 15 can be formed on the dielectric layer 14 by, for instance, an electron beam evaporation technique, an ion plating method, or a sputter technique.

A dielectric layer 22, striped barrier ribs 21 and striped address electrodes 23 are disposed on the rear plate 2. The dielectric layer 22 is disposed so as to cover the address electrodes 23. The barrier ribs 21 are disposed to be in parallel with one another. A phosphor layer 3 is disposed between adjacent barrier ribs 21. The region that is divided with the barrier ribs 21 and that is defined by the intersections between address electrodes 23 and display electrodes 13 in a discharge space 31 serves as a discharge cell. The configuration of the address electrodes 23 can be the same as that of the bus electrodes described above, for example. The dielectric layer 22 can be the same as the dielectric layer 14. The barrier ribs 21 can be formed using, for example, glass and pigments.

The phosphor layer 3 containing the first and second phosphors can be formed by the same method as that for forming a conventional phosphor layer of a PDP. It can be formed by, for example, applying a paste between barrier ribs 21 by screen printing or line jetting, with the paste being obtained by dispersing the first and second phosphors in an organic solvent such as alpha-terpineol that contains ethylcellulose and/or nitrocellulose in a concentration of 5% by weight to 10% by weight, and baking it at a temperature in the range of 450° C. to 550° C. When the first and second phosphors are to be dispersed in the organic solvent, a mixture of the first and second phosphors may be dispersed or they may be dispersed by adding each phosphor individually to the organic solvent.

The front panel 1 and the rear panel 2 are disposed to oppose each other so that the protective layer 15 and the barrier ribs 21 face the discharge spaces 31 and the striped display electrodes 13 and address electrodes 23 are orthogonal to each other when viewed from the principal surfaces of the front panel 1 and the rear panel 2. A sealing member formed of low-melting glass is disposed at the peripheries of the front panel 1 and the rear panel 2, and thereby the airtightness of the discharge spaces 31 is maintained. The discharge spaces 31 are filled with a discharge gas containing an inert gas such as neon or xenon. The pressure of the discharge gas in the discharge spaces 31 is, for example, in the range of 53 kPa to 79 kPa (400 Torr to 600 Torr).

In the PDP 51, a picture signal voltage is applied selectively to the display electrodes 13 to excite the phosphors contained in the phosphor layers 3, and thereby the phosphors thus excited emit blue, green, or blue light. Thus, a color image can be displayed.

A method that is employed commonly as a method of producing a PDP can be used for the method of producing the PDP 51.

The gas discharge light emitting panel of the present invention is not limited to the PDP as shown in FIG. 1. It is not particularly limited, so long as it is a light emitting panel that utilizes light emitted from phosphors by irradiating the phosphors with ultraviolet rays (particularly, vacuum ultraviolet rays with a wavelength of 200 nm or shorter) generated by gas discharge. Examples of such a light emitting panel include not only a PDP but also a backlight for a liquid crystal panel, a character display, and a lighting panel. Particularly, the effect to be obtained is great when the present invention is applied to a PDP in which changes in chromaticity and luminance affect the display properties of the panel considerably.

### EXAMPLES

Hereinafter, the present invention is described in further detail using examples. The present invention is not limited to the following examples.

### Example 1

In Example 1, a PDP was produced that included a phosphor layer A containing SMS and BAM, a phosphor layer B formed of BAM, and a phosphor layer C formed of SMS. With respect to the PDP thus produced, a lighting test was carried out to evaluate the changes in light-emitting properties of each phosphor layer that accompany driving of the panel. The composition of SMS was a=3, b=0.005, and c=2.

First, a paste was formed by dispersing SMS and/or BAM in an alpha-terpineol dispersion solvent containing ethylcellulose (50% by weight). The paste thus formed was applied to a glass substrate by screen printing or line jetting and then the whole was baked at a temperature in the range of 450° C. to 550° C. Thus the phosphor layers A to C were produced. With respect to the phosphor layer A, two types thereof were produced including a phosphor layer A-1 in which the volume fraction of SMS was 25% with respect to the entire phosphors contained in the phosphor layer, and a phosphor layer A-2 in which the volume fraction of SMS was 70 vol %.

Subsequently, a PDP 51 as shown in FIG. 1 was produced using the respective phosphor layers produced above. The PDP 51 was produced according to a general method of producing a PDP. In the production of the PDP 51, in order to prevent variations in changes in light-emitting properties from being caused by differences in atmosphere of the discharge spaces, all the phosphor layers A to C were disposed in one panel.

Next, the PDP 51 thus produced was connected to a common PDP drive unit to be lit continuously, and the changes in luminance (Y/y) and chromaticity y of each phosphor layer with time were measured using a CRT color analyzer (CA-100plus, manufactured by Konica Minolta). In the region of the PDP to be measured for the changes in luminance and chromaticity, white was lit and displayed continuously, and the luminance was evaluated as a relative value of the emission intensity, with the initial value thereof being considered as 100%. The period of time for continuous lighting was 2500 hours, and AC voltage to be applied to the discharge spaces for lighting the panel was 175 V.

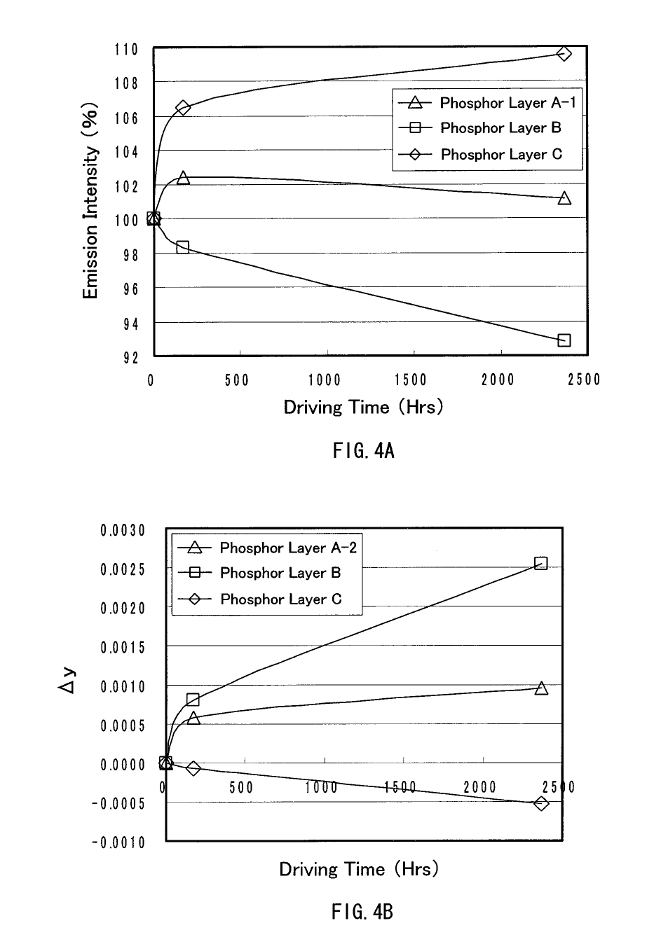

FIG. 4 shows the measurement results. As shown in FIG. 4A, the luminance of the phosphor layer B formed of BAM was decreased by driving of the panel, and the luminance of the phosphor layer C formed of SMS was increased by driving of the panel. On the other hand, in the phosphor layer A-1 containing, as phosphors, 25 vol % of SMS and 75 vol % of BAM, the change in luminance caused by driving of the panel was reduced as compared to the phosphor layer B.

Moreover, as shown in FIG. 4B, the chromaticity y of the phosphor layer B formed of BAM was increased by driving of the panel (in FIG. 4B, the change in chromaticity y is indicated by the amount of change (Δy) from the initial value thereof), while the chromaticity y of the phosphor C formed of SMS was decreased by driving of the panel. On the other hand, in the phosphor layer A-2 containing, as phosphors, 70 vol % of SMS and 30 vol % of BAM, the change in chromaticity y caused by driving of the panel was reduced as compared to the phosphor layer B.

### Example 2

In Example 2, a plurality of SMS phosphor samples containing various amounts of Eu, an activating element, were produced and the changes in luminance thereof were evaluated as light-emitting properties.

SrCO₃, Eu₂O₃, MgO, and SiO₂ were used as starting materials and were weighed so that a predetermined composition was obtained. Thereafter, they were subjected to wet blending in pure water using a ball mill. Subsequently, the mixture thus formed was dried at 150° C. for ten hours and then was baked in the atmosphere at 1100° C. for four hours. It further was baked in a mixed gas containing nitrogen, hydrogen, and oxygen at 1100 to 1300° C. for four hours. Thus a phosphor (SMS) was obtained. In this case, the ratio of divalent Eu in the vicinity of the surface of the phosphor particle was set at 50% or lower by precisely controlling the partial pressure of oxygen in the mixed gas. The ratio of divalent Eu was determined from the intensity ratio (peak area ratio) between the peak caused by divalent Eu and the peak caused by trivalent Eu by using an X-ray photoelectron spectrometer (XPS).

The compositions of the SMS samples produced in Example 2 are indicated as values of a, b, and c in Table 1. In Example 2, eight types of example samples (Samples 1 to 8) in which the value b corresponding to the content of Eu was in the range of 0.001 to 0.03, and one comparative sample (Sample A) in which the value b was 0.1 were produced.

Each sample thus produced was evaluated for (1) luminance in a powder state, which was a state obtained when it was produced, (2) luminance obtained when a phosphor paste formed by mixing with an organic solvent was applied between barrier ribs of the rear panel and was then baked at 500° C. to form a phosphor layer, (3) luminance obtained when a PDP panel was assembled in the same manner as in Example 1 and the panel was then driven for 10 hours, and (4) luminance obtained when the panel was driven for further 1000 hours continuously from the point in time of (3). With respect to (1) and (2), evaluation was made with phosphors, which were in the form of a powder or phosphor layer formed on the rear panel, being irradiated with ultraviolet rays with a wavelength of 145 nm. With respect to (3) and (4), evaluation was made in the same manner as in Example 1. “10 hours” described in (3) corresponds to the period of time, for which an aging treatment generally is conducted in a process of manufacturing a PDP.

Results of the evaluations are indicated in Table 1 below. Results of evaluations made with respect to both phosphors of BAM and CMS (CaMgSi₂O₆:Eu²⁺) also are indicated as conventional examples. The luminance of each sample is evaluated by the value (Y/y) described above and is indicated by a relative value calculated with the luminance of BAM, which is in a powder state, being taken as 100.

TABLE 1

| | | | | | | | | | Rate of change in |
|---|---|---|---|---|---|---|---|---|---|
| | | | | | | | | | luminance caused |
| | SMS | | | Ratio of | | | | | by driving panel |
| | Composition | | | Divalent | Luminance (Y/y) | | | | for 1000 hours |
| Sample No. | a | b | c | Eu (%) | (1) | (2) | (3) | (4) | (%) |
| 1 | 2.97 | 0.03 | 2 | 50 | 100 | 46 | 65 | 66 | 1.5 |
| 2 | 3.5 | 0.001 | 2 | 30 | 102 | 51 | 53 | 55 | 3.8 |
| 3 | 3.1 | 0.003 | 2 | 10 | 120 | 68 | 72 | 75 | 4.2 |
| 4 | 3 | 0.006 | 2 | 5 | 118 | 72 | 88 | 100 | 13.6 |
| 5 | 3 | 0.005 | 2 | 5 | 115 | 74 | 92 | 100 | 8.7 |
| 6 | 3 | 0.004 | 2 | 5 | 110 | 77 | 93 | 103 | 11.1 |
| 7 | 3 | 0.003 | 2 | 5 | 113 | 71 | 83 | 90 | 8.4 |
| 8 | 3 | 0.002 | 2 | 5 | 100 | 82 | 92 | 95 | 3.3 |
| A | 2.9 | 0.1 | 2 | 80 | 42 | 21 | 13 | 12 | −7.7 |
| Comp. | | | | | | | | | |
| Example | | | | | | | | | |
| BAM | — | — | — | — | 100 | 95 | 92 | 83 | −9.8 |
| CMS | — | — | — | — | 95 | 92 | 90 | 85 | −5.6 |

* The value of luminance (Y/y) in each sample is a relative value calculated with the value obtained at the time of (1) of BAM being taken as 100.

As indicated in Table 1, the luminances of BAM and CMS, which were conventional blue phosphors, were (1) highest in the powder state, and continued to decrease in the order of (2) at the time of forming a phosphor layer, (3) after 10 hours from the start of driving of the panel, and (4) after driving the panel for further 1000 hours. When the results obtained at the time of (3) and at the time of (4) are compared to each other, it was found that driving of the panel for 1000 hours caused the luminance of BAM to decrease by about 10% and the luminance of CMS to decrease by about 9.4%.

On the other hand, in Samples 1 to 8, it was found that although the formation of the phosphor layer resulted in a considerable decrease in luminance thereof first, the luminance thereof was increased by driving of the panel. When the results obtained at the time of (3) and at the time of (4) were compared to each other, as indicated in Table 1, driving of the panel for 1000 hours increased the luminance by about 1.5% in Sample 1, about 3.8% in Sample 2, about 4.2% in Sample 3, 13.6% in Sample 4, about 8.7% in Sample 5, about 11.1% in Sample 6, about 8.4% in Sample 7, and about 3.3% in Sample 8.

Conventionally, there is no known phosphor whose luminance tends to be increased by driving of the panel after the luminance has been decreased first due to the formation of a phosphor layer as in the cases of Samples 1 to 8. In Samples 1 to 8, the reason why such a change in luminance occurs is not clear. However, conceivably, the cause could be that thermal deterioration of SMS caused by the heat treatment in forming the phosphor layer is recovered by the atmosphere in which the panel is driven.

### Example 3

In Example 3, the changes in chromaticity y of the SMS phosphor samples produced in Example 2 were evaluated as the light-emitting properties thereof.

Specifically, Example Samples 1 to 8 and Comparative Example Sample A produced in Example 2 each were evaluated for (1) chromaticity y in a powder state, which was a state obtained when it was produced, (2) chromaticity y obtained when a phosphor paste formed by mixing with an organic solvent was applied between barrier ribs of the rear panel and was then baked at 500° C. to form a phosphor layer, (3) chromaticity y obtained when a PDP panel was assembled in the same manner as in Example 1 and the panel was then driven for 10 hours, and (4) chromaticity y obtained when the panel was driven for further 1000 hours continuously from the point in time of (3). With respect to (1) and (2), evaluation was made with phosphors, which were in the form of a powder or phosphor layer formed on the rear panel, being irradiated with ultraviolet rays with a wavelength of 145 nm. With respect to (3) and (4), evaluation was made in the same manner as in Example 1. As described above, “10 hours” described in (3) corresponds to the period of time, for which an aging treatment generally is conducted in a process of manufacturing a PDP.

Results of the evaluations are indicated in Table 2 below. Results of evaluations made with respect to both phosphors of BAM and CMS (CaMgSi₂O₆:Eu²⁺) also are indicated as conventional examples.

TABLE 2

| | | | | | | | | | Amount of |
|---|---|---|---|---|---|---|---|---|---|
| | | | | | | | | | change in |
| | | | | | | | | | chromaticity y |
| | | | | Ratio | | | | | caused by |
| | | | | of Di- | | | | | driving |
| | SMS | | | valent | | | | | panel for |
| Sample | Composition | | | Eu | Chromaticity y | | | | 1000 |
| No. | a | b | c | (%) | (1) | (2) | (3) | (4) | hours |
| 1 | 2.97 | 0.03 | 2 | 50 | 0.0652 | 0.0680 | 0.0752 | 0.0751 | −0.0001 |
| 2 | 3.5 | 0.001 | 2 | 30 | 0.0503 | 0.0527 | 0.0590 | 0.0570 | −0.0020 |
| 3 | 3.1 | 0.003 | 2 | 10 | 0.0559 | 0.0582 | 0.0644 | 0.0640 | −0.0004 |
| 4 | 3 | 0.006 | 2 | 5 | 0.0551 | 0.0573 | 0.0628 | 0.0623 | −0.0005 |
| 5 | 3 | 0.005 | 2 | 5 | 0.0549 | 0.0574 | 0.0617 | 0.0613 | −0.0004 |
| 6 | 3 | 0.004 | 2 | 5 | 0.0550 | 0.0576 | 0.0632 | 0.0627 | −0.0005 |
| 7 | 3 | 0.003 | 2 | 5 | 0.0534 | 0.0558 | 0.0602 | 0.0598 | −0.0004 |
| 8 | 3 | 0.002 | 2 | 5 | 0.0531 | 0.0557 | 0.0600 | 0.0580 | −0.0020 |
| A | 2.9 | 0.1 | 2 | 80 | 0.1200 | 0.1227 | 0.1352 | 0.1355 | 0.0003 |
| Comp. | | | | | | | | | |
| Example | | | | | | | | | |
| BAM | — | — | — | — | 0.0554 | 0.0604 | 0.0643 | 0.0657 | 0.0014 |
| CMS | — | — | — | — | 0.0502 | 0.0530 | 0.0575 | 0.0578 | 0.0003 |

As indicated in Table 2, the chromaticities y of BAM and CMS, which were conventional blue phosphors, were (1) lowest in the powder state, and continued to increase in the order of (2) at the time of forming a phosphor layer, (3) after 10 hours from the start of driving of the panel, and (4) after driving the panel for further 1000 hours. When the results obtained at the time of (3) and at the time of (4) were compared to each other, it was found that driving of the panel for 1000 hours caused the chromaticity y of BAM to increase by 0.0014 and the chromaticity y of CMS to increase by 0.0003.

On the other hand, it was found that although in each of Samples 1 to 8, the chromaticity y had increased once through the formation of the phosphor layer and the aging treatment, it was decreased conversely by subsequent driving of the panel.

Conventionally, there is no known phosphor whose chromaticity y tends to be decreased by driving of the panel after the chromaticity y has been increased due to the formation of a phosphor layer as in the cases of Samples 1 to 8. In Samples 1 to 8, the reason why such a change in chromaticity y occurs is not clear. However, conceivably, the cause could be that thermal deterioration of SMS caused by the heat treatment in forming the phosphor layer is recovered by the atmosphere in which the panel is driven as in the change in luminance described above.

### INDUSTRIAL APPLICABILITY

The present invention can provide a gas discharge light emitting panel that is provided with a phosphor layer containing phosphors in which changes in light emitting properties accompanying driving of the panel occur in the opposite directions to each other, and thereby can prevent the display properties from deteriorating.

1. A gas discharge light emitting panel, comprising:
a front panel and a rear panel that are disposed to oppose each other, with a discharge space being interposed therebetween, and
a phosphor layer that is disposed above a principal surface located on a side of the discharge space of the rear panel and that emits light by being irradiated with ultraviolet rays generated in the discharge space,
wherein the phosphor layer contains first and second phosphors in which changes in at least one property selected from luminance and chromaticity, which accompany driving of the panel, occur in opposite directions to each other.

2. The gas discharge light emitting panel according to claim 1, wherein the change in the first phosphor occurs in a direction in which the luminance increases.

3. The gas discharge light emitting panel according to claim 2, wherein the first phosphor is a phosphor that is represented by a formula, aSrO. bEuO.MgO.cSiO₂, where a, b, and c satisfy the following relationships:
2.97≦a≦3.5,
0.001≦b≦0.03, and
1.9≦c≦2.1.

4. The gas discharge light emitting panel according to claim 2, wherein the luminance of the first phosphor is increased by at least 3% per 1000 hours, for which the panel is driven, with the luminance being indicated by a value (Y/y) obtained by dividing a stimulus value Y in a XYZ color system defined by Commission Internationale de l'Eclairage (CIE) by chromaticity y in a chromaticity coordinate (x, y) based on the color system.

5. The gas discharge light emitting panel according to claim 2, wherein the second phosphor is BaMgAl₁₀O₁₇:Eu²⁺.

6. The gas discharge light emitting panel according to claim 1, wherein the change in the first phosphor occurs in a direction in which chromaticity y decreases in a chromaticity coordinate (x, y) based on a XYZ color system defined by Commission Internationale de l'Eclairage (CIE).

7. The gas discharge light emitting panel according to claim 6, wherein the first phosphor is a phosphor that is represented by a formula, aSrO. bEuO.MgO.cSiO₂, where a, b, and c satisfy the following relationships:
2.97≦a≦3.5,
0.001≦b≦0.03, and
1.9≦c≦2.1.

8. The gas discharge light emitting panel according to claim 6, wherein the second phosphor is BaMgAl₁₀O₁₇:Eu²⁺.

9. The gas discharge light emitting panel according to claim 1, wherein the first and second phosphors are blue phosphors having emission spectrum peaks in a wavelength range of 440 to 470 nm.

10. The gas discharge light emitting panel according to claim 1, being a plasma display panel.

11. A gas discharge light emitting panel, comprising
a front panel and a rear panel that are disposed to oppose each other, with a discharge space being interposed therebetween, and
a phosphor layer that is disposed above a principal surface located on a side of the discharge space of the rear panel and that emits light by being irradiated with ultraviolet rays generated in the discharge space,
wherein the phosphor layer contains a first phosphor represented by a formula, aSrO.bEuO.MgO-cSiO₂, and BaMgAl₁₀O₁₇:Eu²⁺ as a second phosphor, where a, b, and c satisfy the following relationships:
2.97≦a≦3.5,
0.001≦b≦0.03, and
1.9≦c≦2.1.

12. The gas discharge light emitting panel according to claim 11, wherein luminance of the first phosphor is increased by at least 3% per 1000 hours, for which the panel is driven, with the luminance being indicated by a value (Y/y) obtained by dividing a stimulus value Y in a XYZ color system defined by Commission Internationale de l'Eclairage (CIE) by chromaticity y in a chromaticity coordinate (x, y) based on the color system.

13. The gas discharge light emitting panel according to claim 11, which is a plasma display panel.
